(19) United States
(12) Patent Application Publication
(10) Pub. No.: US 2026/0046492 A1
(43) Pub. Date: Feb. 12, 2026

(54) CONTENT DISPLAY METHOD

(71) Applicant: TENCENT TECHNOLOGY (SHENZHEN) COMPANY LIMITED, Shenzhen (CN)

(72) Inventors: Jinchao ZENG, Shenzhen (CN); Shuyuan LI, Shenzhen (CN); Chuanyu ZHANG, Shenzhen (CN); Yitong WANG, Shenzhen (CN); Silin LIU, Shenzhen (CN); Zirui CHENG, Shenzhen (CN); Yanhua ZHAO, Shenzhen (CN); Guiyi YANG, Shenzhen (CN); Tongyi GUO, Shenzhen (CN); Qingqing REN, Shenzhen (CN)

(73) Assignee: TENCENT TECHNOLOGY (SHENZHEN) COMPANY LIMITED, Shenzhen, GD (CN)

(21) Appl. No.: 19/361,408

(22) Filed: Oct. 17, 2025

Related U.S. Application Data
(63) Continuation of application No. PCT/CN2024/109732, filed on Aug. 5, 2024.

(30) Foreign Application Priority Data
Sep. 28, 2023 (CN) 202311288819.8

(51) Int. Cl. H04N 21/81; H04N 21/254; H04N 21/431; H04N 21/466

(52) U.S. Cl. CPC H04N 21/812; H04N 21/2542; H04N 21/4316; H04N 21/4668

(57) ABSTRACT

In a method, an application startup page is displayed when a content application is started. The application startup page includes a promotion content picture associated with a target promotion object and includes a historical content display area. In the method, content information and prompt information are displayed in the historical content display area. The content information is related to target content of which display was interrupted within a historical time period. The prompt information is associated with the target promotion object and indicates resumption of the display of the target content. In the method, based on a first interaction operation on the historical content display area, a content page including a content display area and a promotion area is displayed by processing circuitry, and the display of the target content is resumed in the content display area based on a historical display progress of the target content.

### RELATED APPLICATIONS

The present application is a continuation of International Application No. PCT/CN2024/109732, filed on Aug. 5, 2024, which claims priority to Chinese Patent Application No. 202311288819.8, filed on Sep. 28, 2023 and entitled “CONTENT DISPLAY METHOD AND RELATED DEVICE.” The entire disclosures of the prior applications are hereby incorporated by reference.

### FIELD OF THE TECHNOLOGY

This disclosure relates to the field of computer technologies, including a content display method and apparatus, a medium, a device, and a computer program product.

### BACKGROUND OF THE DISCLOSURE

Currently, with the wide use of playback software for digital content, a user is often interrupted for various reasons when watching or listening to content. As a result, playback of the content cannot be completed. However, when opening the playback software next time, the user needs to perform a series of operations to find a playback record, so as to find, from the playback record, the content interrupted last time and continue to play the content. The operations are complex, and interaction efficiency for performing these operations is low.

### SUMMARY

Embodiments of this disclosure provide a content display method and apparatus, a medium, a device, and a computer program product.

According to an aspect, this disclosure provides a content display method. In the method, an application startup page is displayed when a content application is started. The application startup page includes a promotion content picture associated with a target promotion object and includes a historical content display area. In the method, content information and prompt information are displayed in the historical content display area. The content information is related to target content of which display was interrupted within a historical time period. The prompt information is associated with the target promotion object and indicates resumption of the display of the target content. In the method, based on a first interaction operation on the historical content display area, a content page including a content display area and a promotion area is displayed by processing circuitry, the display of the target content is resumed in the content display area based on a historical display progress of the target content, and promotion content associated with the target promotion object is displayed in the promotion area.

According to an aspect, this disclosure provides a content display apparatus. The content display apparatus includes processing circuitry configured to display an application startup page when a content application is started. The application startup page includes a promotion content picture associated with a target promotion object and includes a historical content display area. The processing circuitry is configured to display content information and prompt information in the historical content display area. The content information is related to target content of which display was interrupted within a historical time period. The prompt information is associated with the target promotion object and indicates resumption of the display of the target content. Based on a first interaction operation on the historical content display area, the processing circuitry is configured to display a content page including a content display area and a promotion area, resume the display of the target content in the content display area based on a historical display progress of the target content, and display promotion content associated with the target promotion object in the promotion area.

According to an aspect, this disclosure provides a non-transitory computer-readable storage medium. The non-transitory computer-readable storage medium stores instructions, which when executed by a processor, cause the processor to perform displaying an application startup page when a content application is started. The application startup page includes a promotion content picture associated with a target promotion object and includes a historical content display area. The instructions, when executed by the processor, cause the processor to perform displaying content information and prompt information in the historical content display area. The content information is related to target content of which display was interrupted within a historical time period. The prompt information is associated with the target promotion object and indicates resumption of the display of the target content. The instructions, when executed by the processor, cause the processor to perform, based on a first interaction operation on the historical content display area, displaying a content page including a content display area and a promotion area, resuming the display of the target content in the content display area based on a historical display progress of the target content, and displaying promotion content associated with the target promotion object in the promotion area.

According to an aspect, this disclosure provides a content display method, performed by an electronic device, and including: displaying an application startup page when a content application is started, the application startup page including a promotion content picture for a target promotion object and a historical content display area; displaying, in the historical content display area, information related to target content that was not completely displayed on the content application in a historical time period, and displaying prompt information associated with the target promotion object, the prompt information being configured for prompting continuation of watching the target content; displaying a content page in response to an interaction operation on the historical content display area, the content page including a content display area and a promotion area; displaying the target content in the content display area based on a historical display progress of the target content; and displaying promotion content for the target promotion object in the promotion area.

According to another aspect, this disclosure provides a content display apparatus, including: a first display unit, configured to: display an application startup page when a content application is started, the application startup page including a promotion content picture for a target promotion object and a historical content display area; and display, in the historical content display area, information related to target content that was not completely displayed on the content application in a historical time period, and display prompt information associated with the target promotion object, the prompt information being configured for prompting continuation of watching the target content; and a second display unit, configured to: display a content page in response to an interaction operation on the historical content display area, the content page including a content display area and a promotion area; display the target content in the content display area based on a historical display progress of the target content; and display promotion content for the target promotion object in the promotion area.

According to still another aspect, this disclosure provides an electronic device, including processing circuitry, such as a processor, and a memory, the memory having a plurality of instructions stored therein, and the processor loading the instructions to perform operations in the content display method provided in the embodiments of this disclosure.

According to yet another aspect, this disclosure provides a non-transitory computer-readable storage medium, having a computer program or instructions stored therein, the computer program or the instructions, when executed by a processor, implementing operations in the content display method provided in the embodiments of this disclosure.

According to still yet another aspect, this disclosure further provides a computer program product, including a computer program or instructions, the computer program or the instructions, when executed by a processor, implementing operations in the content display method provided in the embodiments of this disclosure.

Details of one or more embodiments of this disclosure are provided in the accompanying drawings and descriptions below. Various features, objectives, and advantages of this disclosure are described based on the specification, the accompanying drawings, and the claims.

### BRIEF DESCRIPTION OF THE DISCLOSURE

To describe the technical solutions in one or more embodiments of this disclosure, the following briefly describes the accompanying drawings. The accompanying drawings in the following descriptions show merely non-limiting embodiments of this disclosure. Other embodiments are within the scope of the disclosure.

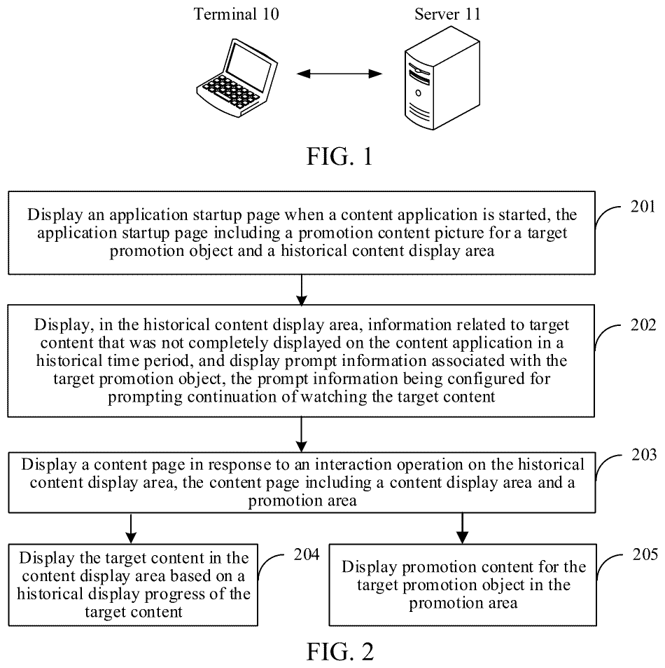

FIG. 1 is a schematic diagram of a scenario of a content display method according to an embodiment of this disclosure.

FIG. 2 is a flowchart of a content display method according to an embodiment of this disclosure.

FIG. 3 is a schematic diagram of a page of a content display method according to an embodiment of this disclosure.

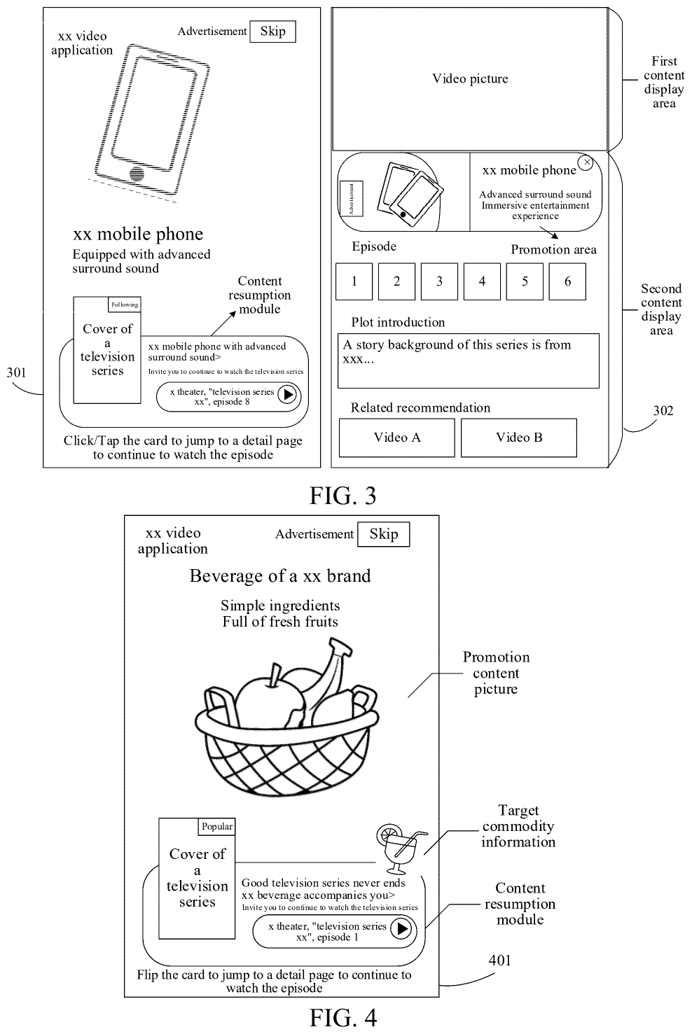

FIG. 4 is a schematic diagram of another page of a content display method according to an embodiment of this disclosure.

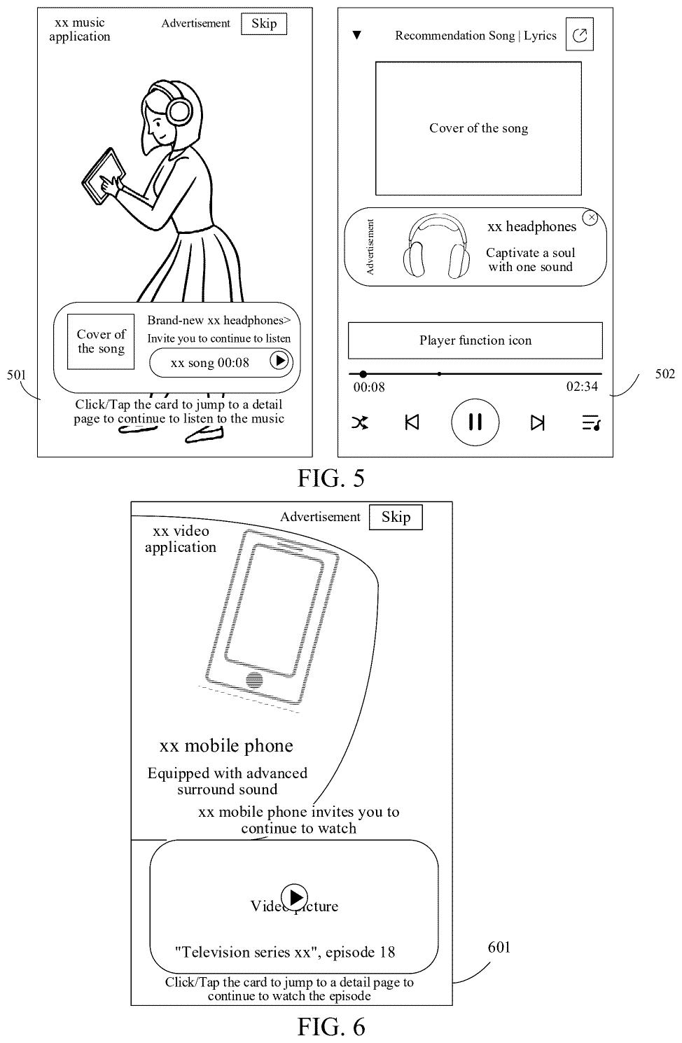

FIG. 5 is a schematic diagram of another page of a content display method according to an embodiment of this disclosure.

FIG. 6 is a schematic diagram of another page of a content display method according to an embodiment of this disclosure.

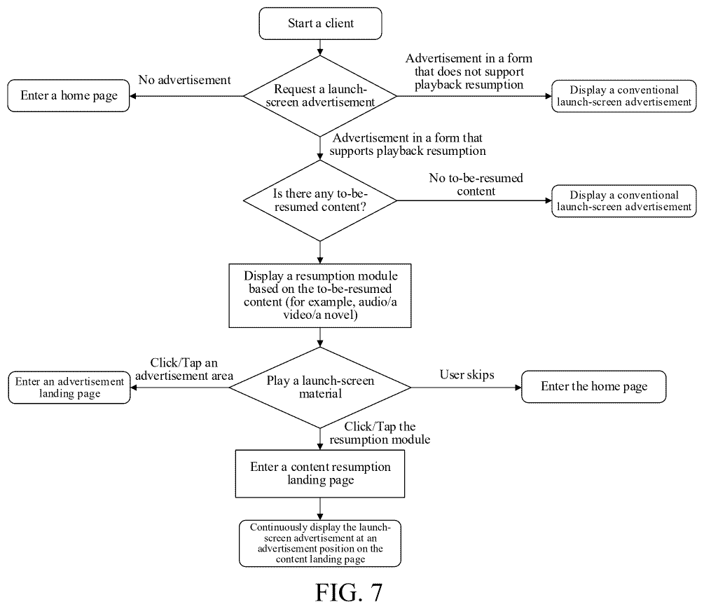

FIG. 7 is another flowchart of a content display method according to an embodiment of this disclosure.

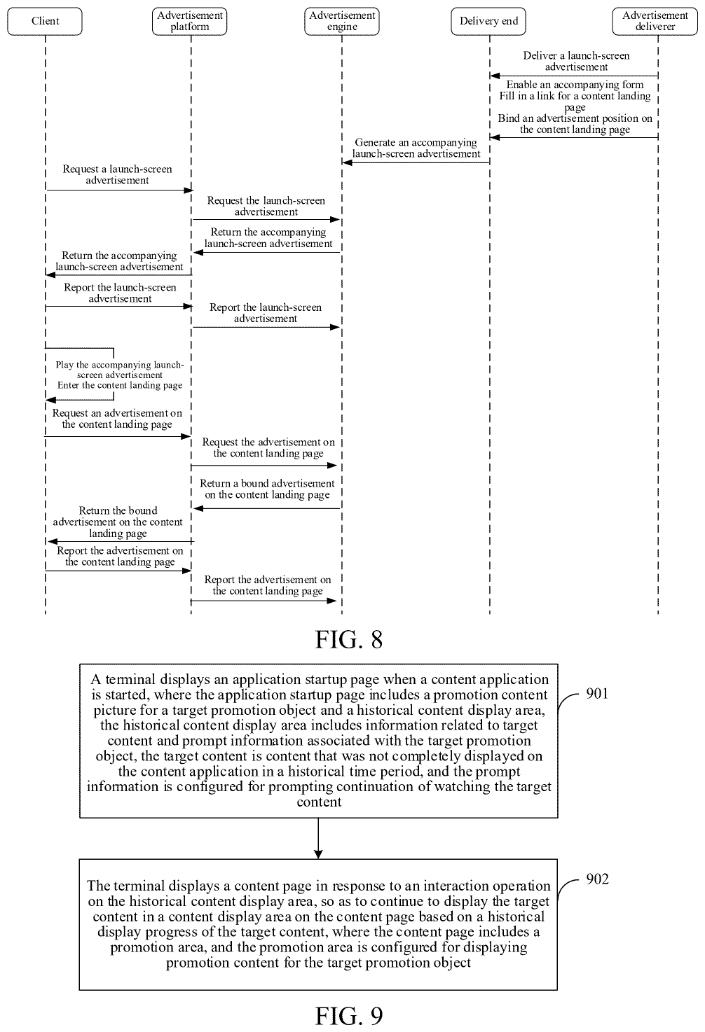

FIG. 8 is another flowchart of a content display method according to an embodiment of this disclosure.

FIG. 9 is another flowchart of a content display method according to an embodiment of this disclosure.

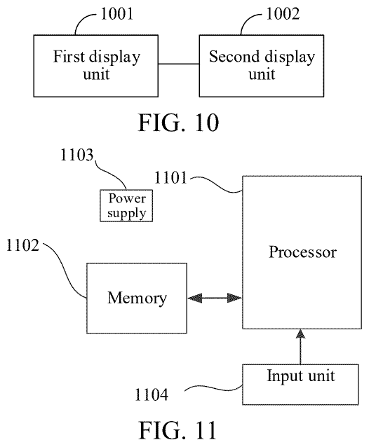

FIG. 10 is a schematic structural diagram of a content display apparatus according to an embodiment of this disclosure.

FIG. 11 is a schematic structural diagram of an electronic device according to an embodiment of this disclosure.

### DESCRIPTION OF EMBODIMENTS

The technical solutions in one or more embodiments of this disclosure are described below with reference to the accompanying drawings. The embodiments are described merely as non-limiting examples of this disclosure. Other embodiments based on one or more embodiments of this disclosure are within the scope of this disclosure.

Embodiments of this disclosure provide a content display method and apparatus, a medium, a device, and a computer program product. The content display apparatus may be specifically integrated into an electronic device, and the electronic device may be a terminal, a server, or another device.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

As shown in FIG. 1, an example in which a terminal and a server jointly perform a content display method is used. A content display system provided in this embodiment of this disclosure includes a terminal 10, a server 11, and the like. The terminal 10 and the server 11 are connected through a network, for example, are connected through a wired or wireless network. A content display apparatus may be integrated into the terminal.

The terminal 10 may be configured to: display an application startup page when a content application is started, the application startup page including a promotion content picture for a target promotion object and a historical content display area; display, in the historical content display area, information related to target content that was not completely displayed on the content application in a historical time period, and display prompt information associated with the target promotion object, the prompt information being configured for prompting continuation of watching the target content; display a content page in response to an interaction operation on the historical content display area, the content page including a content display area and a promotion area; display the target content in the content display area based on a historical display progress of the target content; and display promotion content for the target promotion object in the promotion area. The terminal 10 may include a mobile phone, a smart television, a tablet computer, a notebook computer, an intelligent in-vehicle terminal, a personal computer (PC), or the like. The terminal 10 may be further provided with a client. The client may be an application program client, a browser client, or the like.

The server 11 may be configured to: transmit the promotion content for the target promotion object to the terminal 10. The server 11 may be a single server, a server cluster including a plurality of servers, or a cloud server.

Detailed descriptions are separately provided below. A description order of the following embodiments is for illustration purposes and is not intended to limit this disclosure.

Embodiments will be described from a perspective of a content display apparatus. The content display apparatus may be specifically integrated into an electronic device, and the electronic device may be a server, a terminal, or another device.

As shown in FIG. 2, a specific procedure of the content display method may include the following operations.

Operation 201: Display an application startup page when a content application is started, the application startup page including a promotion content picture for a target promotion object and a historical content display area. In one example, an application startup page is displayed when a content application is started. The application startup page includes a promotion content picture associated with a target promotion object and includes a historical content display area.

The content application may be various playback software for digital content, including, but not limited to, applications such as video playback, music playback, e-book reading, online education, and game applications. In some embodiments, the content application may be specifically a third-party application program of a smartphone, and the third-party application program is an application program other than a program built in an operating system.

The application startup page may also be referred to as a launch screen, and may be a page that is quickly displayed when an application program is started, and may be a page that is in the application program and on which operation personnel can configure display content. The launch screen may be configured to display some brands, advertisements, activities, and the like. In this embodiment, content that was not completely displayed historically (for example, the display or playback of the content was interrupted before the display or playback of the entire content is completed) for a user may be combined with the launch screen. This can improve a click-through rate of the user for promotion content on the application startup page.

The target promotion object is a to-be-promoted object. The target promotion object may be a product, and the product may be a physical product or a virtual product. In some embodiments, the target promotion object may be a public figure, such as an actor or a singer. In some embodiments, the target promotion object may be an activity, such as an exposition or an exhibition. In some embodiments, the target promotion object may be a place, such as a city or a scenic spot. This is not limited in this embodiment. The target promotion object may be pushed to the user in various content forms (for example, text, a picture, audio, and a video) through the Internet.

The promotion content picture for the target promotion object may correspond to a picture formed for displaying promotion content for the target promotion object. The promotion content may be an advertisement, public welfare publicity information, or the like. The promotion content picture for the target promotion object may be static or dynamic. The promotion content picture for the target promotion object may be referred to as a launch-screen advertisement. The launch-screen advertisement is a form of advertisement that is loaded when the content application is started, and after display is completed, the advertisement is automatically closed for entering an application main page.

Operation 202: Display, in the historical content display area, information related to target content that was not completely displayed on the content application in a historical time period, and display prompt information associated with the target promotion object, the prompt information being configured for prompting continuation of watching the target content. In one example, content information and prompt information may be displayed in the historical content display area. The content information is related to target content of which display was interrupted within a historical time period. The prompt information is associated with the target promotion object and indicates resumption of the display of the target content.

Specifically, a terminal may be configured to: display the application startup page when the content application is started, where the application startup page includes the promotion content picture for the target promotion object and the historical content display area, the historical content display area includes the information related to target content and the prompt information associated with the target promotion object, the target content is the content that was not completely displayed on the content application in the historical time period, and the prompt information is configured for prompting continuation of watching the target content.

The prompt information associated with the target promotion object is for prompting, by using the target promotion object, the user to continue to watch content that was not completely displayed historically. In some embodiments, the prompt information includes identification information of the target promotion object, for example, a trademark or a vendor name of the target promotion object. For example, when the target promotion object is a mobile phone, the promotion content picture for the target promotion object may be an introduction picture for the mobile phone. The prompt information associated with the target promotion object may be “xx mobile phone with advanced surround sound, invite you to continue to watch the television series”, as shown in a page 301 in FIG. 3.

In this embodiment, the historical content display area is a content resumption module, and the information related to the target content in the historical content display area may include a historical display progress, a content title, content description, and the like. This is not limited in this embodiment. Specifically, if the target content is a video, the information related to the target content may be a video picture, a video clip (for example, a video opening clip or a video climax clip), or the like.

The historical content display area may be displayed on the application startup page in a form of a card. The historical display progress is specifically corresponding progress information of completed display when display of the target content is interrupted in the historical time period. For example, when the target content is video content, the historical display progress may be watching to a specific second into a specific episode last time. The target content may be content that was not completely displayed on the content application in the historical time period. Specifically, the target content may be content that was not completely displayed when the content application is used last time, and the target content is also to-be-resumed content in a process of starting the content application this time. The historical time period may be set based on an actual situation. For example, the historical time period may be set to be within the last three days or within 24 hours, or may only be set to a time period corresponding to last use.

The target content is specific content, and is specifically the content that was not completely displayed on the content application in the historical time period. The target content may be in a plurality of forms, for example, may be text, a picture, audio, and a video. Specifically, the target content may be a novel, a comic, music, a television series, a game, or the like.

Operation 203: Display a content page in response to an interaction operation on the historical content display area, the content page including a content display area and a promotion area. In one example, based on a first interaction operation on the historical content display area, a content page is displayed. The content page includes a content display area and a promotion area.

The interaction operation on the historical content display area may be specifically voice interaction, gesture interaction, or the like. The gesture interaction herein may include completing interaction by using a sliding gesture, a tilting gesture, or the like.

Operation 204: Display the target content in the content display area based on the historical display progress of the target content. In one example, based on a first interaction operation on the historical content display area, the display of the target content is resumed in the content display area based on a historical display progress of the target content.

In some embodiments, an interruption point corresponding to the previous display of the target content may be determined based on the historical display progress of the target content, and further, the target content continues to be displayed on the content display area by using the interruption point as a starting point.

Operation 205: Display the promotion content for the target promotion object in the promotion area. In one example, based on a first interaction operation on the historical content display area, promotion content associated with the target promotion object is displayed in the promotion area.

The promotion content displayed in the promotion area on the content page and the promotion content picture on the application startup page are for the same promotion subject. The promotion content displayed in the promotion area on the content page and the promotion content picture on the application startup page may be generated by an advertisement engine for the target promotion object. The promotion content displayed in the promotion area on the content page is a bound advertisement that is on a content landing page and that is generated for the target promotion object. The promotion content picture on the application startup page is a launch-screen advertisement.

In this disclosure, content information of the content that was not completely displayed historically on the content application may be directly displayed on the application startup page. Directly jumping to the corresponding content page for continuing to display the target content can be performed through the interaction operation. This can help the user to quickly return to the previously uncompleted content, reduce complexity of user operations, have high interaction efficiency, and avoid unnecessary resource waste caused by complex operations. In addition, the user can be prevented from spending a large amount of time and energy to search for the previously uncompleted content. This is conductive to improving user satisfaction on the content application, thereby improving a user retention rate. In addition, in cooperation with display of the content information of the target content that was not completely displayed historically, the promotion content on the application startup page can attract more attention of the user, thereby improving an interaction rate and a conversion rate of the promotion content.

In some embodiments, the application startup page further includes a content recommendation area, and the content display method further includes: displaying information related to recommended content (for example, recommendation information) in the content recommendation area, the recommended content being determined based on historical usage behavior information generated in the content application; and displaying a recommended content page in response to an interaction operation on the content recommendation area, and displaying the recommended content on the recommended content page.

The recommended content may be recommended content determined from a content database of the content application based on the historical usage behavior information of the content application. The content database of the content application may include all content published on the content application. The information related to the recommended content displayed in the content recommendation area may include content description information, predicted watching duration, and the like. This is not limited in this embodiment.

The interaction operation on the content recommendation area may include a gesture operation, a voice interaction operation, or the like on the content recommendation area. For example, the interaction operation on the content recommendation area may be a click/tap operation or a sliding operation on the content recommendation area. For another example, the interaction operation on the content recommendation area may be preset voice interaction information for the content recommendation area, for example, voice interaction information like “watch the recommended content” may be set. When the preset voice interaction information for the content recommendation area is detected, the recommended content page may be displayed.

The historical usage behavior information may include historically watched content, content that was not completely watched last time, and the like. This is not limited in this embodiment. In some embodiments, content similar to the historically watched content may be obtained from the content database of the content application as the recommended content.

In this embodiment, on the application startup page, the promotion content picture and the historical content display area are displayed, and the information related to the recommended content may also be displayed. In addition, the recommended content is determined based on the historical usage behavior information generated in the content application. In this way, content that better meets requirements of the user can be recommended. This provides convenience for the user. In addition, richer information is displayed on the application startup page, so that complex operations of searching for content by the user can be reduced, operation efficiency is improved, and unnecessary resource consumption is reduced.

In this embodiment, other more targeted content recommendation may be provided on the application startup page with reference to a playback history and a playback pause point, to improve a click-through rate of the content recommendation.

In some embodiments, the recommended content may be determined with reference to a scenario in which the user is located and the historical usage behavior information, to push content on the launch screen. The scenario in which the user is located may be determined by using at least one of a positioning location of the user, map information, or time information. For example, if the positioning location of the user is at a point of interest on a map, the point of interest is a classroom, and a current time point is within class time, it can be determined that the scenario in which the user is located is taking a class in a classroom.

For example, if the scenario in which the user is located is taking a class in a classroom, and the historical usage behavior information of the user includes a learning video and a game video, learning content may be selected from the content database for recommendation and display.

In this embodiment, the recommended content may be determined with reference to the scenario in which the user is located and the historical usage behavior information, so that content more suitable for the requirements of the user may be recommended to the user, thereby further improving the operation efficiency and reducing the unnecessary resource consumption.

In some embodiments, the content recommendation area may be disposed below the historical content display area. An area of the historical content display area may be greater than an area of the content recommendation area. In this embodiment, the historical content display area is used as an area for displaying primary information, and the content recommendation area is used as an area for displaying secondary information. This is conducive to catching user attention to key information, and avoids reduction in the interaction efficiency caused because the user cannot pay attention to the key information timely due to an excessively large amount of information.

In some embodiments, the application startup page includes a promotion content area, and the content display method further includes: displaying the promotion content picture for the target promotion object (for example, associated with the target promotion object) in the promotion content area; and displaying a promotion content page for the target promotion object in response to a trigger operation on the promotion content area.

The application startup page includes the promotion content area, and the promotion content area includes the promotion content picture for the target promotion object. The promotion content area may be specifically another area other than the historical content display area on the application startup page, and the promotion content area may be an advertisement area on the launch screen. The trigger operation on the promotion content area may be specifically a click/tap operation, a sliding operation, or the like. This is not limited in this embodiment. Through the trigger operation on the promotion content area, an advertisement landing page may be entered, to be specific, the promotion content page for the target promotion object is entered. The advertisement landing page is a specific page, is a target page entered after the user clicks/taps an advertisement, and may be configured for guiding the user to perform a specific action, for example, an action like purchasing, registering, or downloading.

In this embodiment, when the user is interested in the promotion content picture, the user may trigger to enter the promotion content page for the target promotion object, to view more detailed information about the target promotion object. In this way, the application startup page serves as a first-level page, and the promotion content page serves as a second-level page. Through the operation of the two levels of pages, both the operation efficiency and disturbance to the user are considered, thereby improving user experience.

In some embodiments, the content display area includes a first content display area and a second content display area, the first content display area is configured for displaying the target content, and the content display method further includes: displaying content description information of the target content in the second content display area; and superimposing the promotion area on the second content display area, and highlighting the promotion area with a preset effect.

If the target content is a video, the content description information may be a video poster, plot introduction, or the like. The video poster may include description information of the target content, and the description information may include an image, text, a video, audio, and the like.

The preset effect is configured for displaying the promotion area more prominently than the second content display area. The preset effect may be that there is no shadow on the promotion area, and an area that is in the second content display area and that is covered by the promotion area has reduced brightness, darkened color, or is covered by a shadow. In some embodiments, the preset effect may be that definition of the promotion area is higher than definition of the area that is in the second content display area and that is covered by the promotion area. In one example, the promotion area is highlighted based on a first display definition. In one example, the second content display area is displayed based on a second display definition. In one example, the second display definition corresponds to having a lower resolution, a lower brightness level, a stronger blur effect, a stronger shadow effect, or a combination thereof, than the first display definition (which may be referred to as the first display definition being higher than the second display definition or the second display definition being lower than the first display definition in this disclosure).

For example, the target content is a video. As shown in a page 302 in FIG. 3, the first content display area is configured for displaying a video picture, the second content display area is located below the first content display area, and the second content display area may include the content description information such as an episode and a plot introduction. The promotion area is superimposed on the second content display area. The area that is in the second content display area and that is covered by the promotion area may be darkened or may be added with a shadow layer, to downplay display of the area that is in the second content display area and that is covered by the promotion area.

In this embodiment, the content description information of the target content is displayed in the second content display area. The promotion area is superimposed on the second content display area and is highlighted with the preset effect. This can guide the user to pay attention to content in the promotion area, and avoid interference to viewing the target content and the content description information by the user. In this way rich information is provided for the user.

In some embodiments, definition of the second content display area is lower than definition of the first content display area and the definition of the promotion area. In this way, content in the first content display area and content in the promotion area are highlighted, so that the user can pay more attention to the target content and the promotion content, and the user can conveniently view the target content and the promotion content. In this way, rich information is provided for the user.

In some embodiments, the promotion area is highlighted at first definition, the second content display area is displayed at second definition, the first definition is higher than the second definition, and the content display method further includes: hiding the promotion area in response to a close operation on the promotion area, and displaying the second content display area at the first definition.

The first definition may be a display mode without shadow, and the second definition may be a display mode with shadow. The first definition may be a display mode with first brightness, the second definition may be a display mode with second brightness, and the first brightness is higher than the second brightness. The first definition may be a display mode without a blur effect, and the second definition may be a display mode with a blur effect. The first definition may be a display mode with a first blur degree, the second definition may be a display mode with a second blur degree, and the first blur degree is lower than the second blur degree.

For example, the promotion area may include an area close control, as shown in the page 302 in FIG. 3. An icon at the upper right corner of the promotion area is the area close control. Based on a trigger operation (for example, a click/tap operation or a sliding operation) on the area close control, the promotion area may not be displayed on the content page, and the originally blurred second content display area is displayed with enhanced display quality.

In this embodiment, the promotion area and the second content display area are displayed at different definition, and the user may trigger to hide the promotion area and display the second content display area at the first definition. In this way, after it is determined that the user is not interested in the information in the promotion area, the information in the second content display area is displayed with enhanced display quality. Whether the information in the promotion area is required by the user is determined through few interaction operations of the user. After it is determined that the information in the promotion area is not information required by the user, information required by the user is automatically displayed in a clearer manner. In this way, operation convenience is improved and disturbance to the user is reduced.

In some embodiments, the displaying the target content in the content display area based on the historical display progress of the target content includes: displaying, in the content display area on the content page based on the historical display progress of the target content, a content segment associated with a target content segment in the target content, the target content segment being a content segment that is in the target content and that was not completely displayed. In one example, the display of the target content was interrupted within the historical time period at the target content segment.

The content segment associated with the target content segment may be referred to as an associated content segment, may be the content segment that is in the target content and that was not completely displayed, or may be a content segment adjacent to the content segment that is in the target content and that was not completely displayed. The content segment associated with the target content segment may be the target content segment itself, or may be the content segment adjacent to a time period corresponding to the target content segment. This is not limited in this embodiment.

In this embodiment, the target content exists in a form of a content segment, facilitating efficient positioning of the target content segment that was not completely displayed, and improving interaction efficiency.

In some embodiments, the content display method further includes: displaying, in the historical content display area, target commodity information integrated with the information related to target content, the target commodity information being commodity information associated with the target promotion object.

The historical content display area may include the target commodity information integrated with the information related to target content. The target commodity information integrated with the information related to the target content is displayed in the historical content display area, so that the user can pay more attention to advertised commodity information, to help the user perform a high-efficiency interaction operation.

Specifically, as shown in a page 401 in FIG. 4, the target promotion object is a beverage of a xx brand, and a promotion content picture corresponding to the target promotion object may be displayed in the advertisement area of the application startup page. The promotion content picture may include text content “Beverage of a xx brand, simple ingredients, full of fresh fruits” and picture content corresponding to “a basket of fresh fruits”. The application startup page may further include a content resumption module (namely, the foregoing historical content display area). The content resumption module may include information related to the target content of target content “television series xx” that was not completely displayed historically. The information related to the target content may include a cover of the television series, progress information (for example, episode one), and the like. The content resumption module may further include prompt information associated with the target promotion object “Good television series never ends, xx beverage accompanies you, invite you to continue to watch the television series”. In addition, advertised commodity information (a pattern of orange juice) may be further displayed at the upper right corner of the content resumption module, so that the commodity information is exposed and is integrated with the information related to target content of the television series, to provide rich information for the user.

In some embodiments, the displaying an application startup page when a content application is started includes: displaying the application startup page when the content application is started and there is content that was not completely displayed in the historical time period. In this embodiment, when it is determined that the content application is started and there is content that was not completely displayed in the historical time period, the application startup page is displayed. In one example, the application startup page is displayed based on presence of the target content of which the display was interrupted within the historical time period. This can avoid a failure of displaying the target content that was not completely displayed caused because there is no content that was not completely displayed in the historical time period, so that reliability of the content application is improved.

In some embodiments, the content display method further includes: displaying an original application startup page when the content application is started and there is no content that was not completely displayed in the historical time period, the original application startup page including the promotion content picture for the target promotion object and not including the historical content display area. The original application startup page may be a launch-screen advertisement, and the original application startup page does not include the content resumption module. In this embodiment, when it is determined that the content application is started and there is no content that was not completely displayed in the historical time period, the original application startup page is displayed. In one example, an original application startup page is displayed when the content application is started based on absence of any content of which display was interrupted within the historical time period. This can avoid a display error generated due to a failure of displaying the target content that was not completely displayed caused because there is no content that was not completely displayed in the historical time period, so that compatibility of the content application is improved.

In some embodiments, the content display method further includes: displaying a preset application startup page when the content application is started and there is no content that was not completely displayed in the historical time period, the preset application startup page including the promotion content picture for the target promotion object and a preset content display area, the preset content display area including information related to preset content, and the preset content being content bound to the target promotion object; and displaying, in response to an interaction operation on the preset content display area, a content page corresponding to the preset content. In one example, a preset application startup page is displayed when the content application is started based on absence of any content of which display was interrupted within the historical time period. In one example, the preset application startup page includes the promotion content picture associated with the target promotion object and a preset content display area. In one example, the preset content display area includes bound content information related to preset content bound to the target promotion object.

The preset application startup page does not include the content resumption module, and the preset content is content bound to a target promotion content subject. The preset content may be a television series invested by an advertiser corresponding to the target promotion object. The interaction operation on the preset content display area may be a gesture operation, a voice interaction operation, or the like.

In this embodiment, when the content application is started and there is no content that was not completely displayed in the historical time period, information related to the target promotion object and information related to specific content may still be displayed on the preset application startup page, and the application startup page may still be used to provide rich information for the user, thereby avoiding resource waste.

In some embodiments, the application startup page further includes a jump control. The content display method may further include: displaying an application main page of the content application in response to a trigger operation on the jump control.

The trigger operation on the jump control may be specifically a click/tap operation on the jump control. This is not limited in this embodiment. The application main page of the content application may be specifically a home page of the content application. Through the trigger operation on the jump control, display of the launch-screen advertisement may be skipped, and the application main page may be directly entered.

In this embodiment, when the user is not interested in information on the application startup page, the user may directly skip the application startup page and enter the application main page. This avoids interference to normal use of the content application by the user and improve operation efficiency of the user.

In some embodiments, the content display method may further include: displaying the application main page of the content application when no trigger operation on the application startup page is detected in a preset time period.

The trigger operation herein may include a voice trigger operation, a gesture trigger operation, and the like. The preset time period may be set according to an actual situation. For example, the preset time period may be set to 10 seconds. In some embodiments, the application main page of the content application may be displayed after display of the promotion content picture on the application startup page is completed.

In this embodiment, when the user does not perform an operation on the application startup page in the preset time period, it may be determined that the user is not interested in the information on the application startup page. In this case, the user may directly skip the application startup page and enter the application main page. This can avoid the interference to normal use of the content application by the user and improve the operation efficiency of the user.

In some embodiments, the displaying a content page in response to an interaction operation on the historical content display area includes: extracting semantic feature information from collected voice information; calculating a matching degree between the voice information and preset voice interaction information based on the semantic feature information of the voice information and semantic feature information of the preset voice interaction information corresponding to the historical content display area; and displaying the content page based on the matching degree.

When it is detected that the matching degree between the voice information and the preset voice interaction information is higher than a preset matching degree, it may be determined that the user selects the historical content display area, and further, a corresponding content page is displayed.

In the content display method, voice information of the user may be recognized, and the voice information of the user is matched with the preset voice interaction information, to determine whether the user intends to select the historical content display area.

The extracting the semantic feature information from the obtained voice information may specifically include: converting the voice information into text description information, and then extracting semantic feature information from the text description information.

The semantic feature information of the voice information and the semantic feature information of the preset voice interaction information may be extracted by using a neural network. The neural network may be a residual network (ResNet), a dense convolutional network (DenseNet), or the like. However, the neural network in this embodiment is not limited to the several types listed above. Semantic recognition and matching are performed by using the neural network. By using a model good enough, a higher error-tolerance rate can be achieved, and the voice information of the user can be matched more accurately.

The semantic feature information of the voice information may be specifically a semantic feature vector of the voice information, and the semantic feature information of the preset voice interaction information may be specifically a semantic feature vector of text information corresponding to the preset voice interaction information. A vector distance between the semantic feature vector of the voice information and the semantic feature vector of the text information corresponding to the preset voice interaction information may be calculated, and a matching degree between the voice information and the text information corresponding to the preset voice interaction information is determined based on the vector distance. A larger vector distance indicates a lower matching degree. A smaller vector distance indicates a higher matching degree.

The displaying the content page based on the matching degree may be: displaying the content page if the matching degree is higher than or equal to a preset threshold, or performing no action if the matching degree is lower than the preset threshold.

In some embodiments, when it is determined that the matching degree is lower than the threshold, the terminal may re-collect the voice information, extract semantic feature information from the re-collected voice information, and calculate a matching degree between the voice information and the preset voice interaction information based on the semantic feature information of the voice information and the semantic feature information of the preset voice interaction information corresponding to the historical content display area. If the matching degree calculated by using the re-collected voice information is still lower than the preset threshold, and similarity between the re-collected voice information and the originally collected voice information is higher than a preset similarity threshold, the preset threshold may be reduced based on a preset step size. If the matching degree calculated by using the re-collected voice information is higher than or equal to a reduced preset threshold, the content page is displayed. If the matching degree calculated by using the re-collected voice information is still lower than the reduced preset threshold, re-collecting semantic information may be performed again. The content page is displayed until the matching degree calculated by using the re-collected voice information is higher than or equal to the reduced preset threshold.

In this embodiment, the content page is opened by using voice control. This further improves operation convenience.

This disclosure relates to a user experience optimization method based on a launch-screen advertisement. In this method, a resumption box (namely, the foregoing historical content display area) for content that was not completely displayed historically may be provided on a flash-screen page. The user may click/tap the resumption box to enter a content resumption page, and reach, with one click/tap, a content page from which the user previously left, thereby enhancing more user experience. In some embodiments, the user may click/tap a launch screen area (the launch screen page other than the resumption box) to enter an advertisement landing page.

Specifically, in this embodiment, when starting software, the user first sees a dynamic launch-screen advertisement. This is not only for commercial propaganda, but also provides a time window for transition to a subsequent function. A special “content resumption module” appears conspicuously below the launch-screen advertisement. The module displays in detail a title, a progress bar, and a short description of the content that was not completely played last time when the user left the software. The user only needs to simply click/tap or touch the “content resumption module”, and the system automatically and seamlessly jumps to the content page that was not completely displayed last time. In this manner, for the system, trouble of searching for and backtracking uncompleted content by the user is significantly reduced, and continuous and immersive experience of the user are greatly enhanced.

In a specific scenario, FIG. 3 shows a complete interaction process of a launch screen. The page 301 is a schematic diagram of an application startup page. Specifically, the content application is a video application. When the video application is started, the application startup page may be displayed. The application startup page includes a launch-screen advertisement. A target promotion object of the launch-screen advertisement herein may be a xx mobile phone, and a promotion content picture for the target promotion object includes a pattern of the mobile phone and text content “xx mobile phone, equipped with advanced surround sound”. A content resumption module is below the launch-screen advertisement. The content resumption module may display information related to target content that was not completely displayed in a historical time period, for example, progress information of watching the “television series xx” to episode eight last time, and a cover of the television series. The content resumption module may further include prompt information associated with the target promotion object “xx mobile phone with advanced surround sound, invite you to continue to watch the television series”. In addition, prompt information “Click/Tap the card to jump to a detail page to continue to watch the episode” may be further included below the content resumption module. When clicking/tapping the content resumption module, the user is taken to a content detail page (namely, the foregoing content page, as shown in the page 302) from the application startup page, and the video content that was not completely played last time continues to be played. The content detail page may further include a promotion area, and advertisement content (a pattern of the mobile phone and text content “xx mobile phone, advanced surround sound, immersive entertainment experience”) is exposed in the promotion area. If the user clicks/taps a launch-screen advertisement area on the page 301, the user is taken to an advertisement landing page.

The application startup page may further include the jump control, that is, an icon corresponding to “Skip” on the page 301 in FIG. 3. Based on the trigger operation on the jump control, jumping from the application startup page to the application main page may be directly performed.

In another embodiment, the content application is an audio application. When the audio application is started, an application startup page as shown in a page 501 in FIG. 5 may be displayed. The application startup page may include a launch-screen advertisement and a content resumption module corresponding to music that was not completely played last time. A target promotion object thereof is headphones. The launch-screen advertisement may be a person wearing headphones. The content resumption module may include a cover of a song that was not completely played last time and listening progress information 00:08. The content resumption module may further include prompt information associated with the target promotion object “Brand-new xx headphones, invite you to continue to listen”. In addition, prompt information “Click/Tap the card to jump to a detail page to continue to listen to the music” may be further included below the content resumption module. When clicking/tapping the content resumption module, the user is taken to a music playback page (namely, the foregoing content page, as shown in a page 502) from the application startup page, to continue to play. The music playback page may further include a promotion area, and advertisement content (a pattern of the headphones and text content “xx headphones, captivate a soul with one sound”) is exposed in the promotion area. If the user clicks/taps a launch-screen advertisement area on the page 501, the user is taken to an advertisement landing page.

Specifically, in some embodiments, as shown in a page 601 in FIG. 6, an outer layer of the content resumption module may be further in a form of a native player, to highlight the “target content”, and the target content is displayed by using a content cover. The prompt information associated with the target promotion object “xx mobile phone, invite you to continue to watch” may be displayed above the target content.

In some embodiments, the application startup page may be switched to the content page in response to an interaction operation on the content resumption module. Specifically, in a switching process, a transition animation may be displayed, and the transition animation may present an interaction effect. For example, the content resumption module is displayed in a form of a card, the interaction operation may be a flipping gesture, and in this case, the transition animation may be an animation of flipping the card.

FIG. 7 is a flowchart of a content display method according to this disclosure. Specifically, when it is detected that a client (namely, the content application in the foregoing embodiment) is started, the client may request a launch-screen advertisement from a server. Three cases may be included based on a request result. The three cases are respectively as follows:
1. If there is no advertisement, a home page of the client, namely, an application main page, is directly entered.
2. If the requested launch-screen advertisement is an advertisement in a form that does not support playback resumption, a launch-screen advertisement may be directly displayed. The advertisement in the form that does not support playback resumption is specifically an advertisement that cannot support display of a content resumption module.
3. If the requested launch-screen advertisement is an advertisement in a form that supports playback resumption, whether the client has to-be-resumed content may be detected. If the client does not have to-be-resumed content, a launch-screen advertisement is directly displayed. If the client has to-be-resumed content, the content resumption module may be displayed on a launch screen based on a content form (for example, audio/video/novel) of the to-be-resumed content, and a delivered advertisement material is synchronously played on the launch screen.

When a user chooses to skip the launch-screen advertisement, for example, clicks/taps to select an icon corresponding to “Skip” in the upper left corner in FIG. 3, the user may directly enter the home page from a launch-screen page. When the user chooses to click/tap an advertisement area (namely, the area other than the historical content display area on the application startup page in the foregoing embodiment), an advertisement landing page is directly entered. When the user chooses to click/tap the resumption module (namely, the historical content display area in the foregoing embodiment), a content resumption landing page, namely, a content page, is entered, and the launch-screen advertisement is continuously displayed at an advertisement position on the content resumption landing page.

FIG. 8 is a sequence diagram of a content display method according to this disclosure, which may relate to five execution bodies: a client, a supply-side platform (SSP) background, an advertisement engine, a delivery end, and an advertisement deliverer. The SSP background is a supplier platform, is an advertisement platform serving a medium end, and is also referred to as a medium management platform. The sequence diagram may be mainly divided into two procedures: an advertisement creation procedure and an advertisement playback procedure. Details are as follows:

In the advertisement creation procedure, the advertisement deliverer first delivers a launch-screen advertisement. If a current playback form of the launch-screen advertisement supports a resumption module, the advertisement deliverer may choose to enable an accompanying form, to be specific, fill in an additional link for a content landing page, and bind an advertisement position on the content landing page. The advertisement engine generates both a launch-screen advertisement and a bound advertisement on the content landing page.

In the advertisement playback procedure, when the client requests a launch-screen advertisement, if there is an available accompanying launch-screen advertisement, the advertisement background delivers the corresponding accompanying launch-screen advertisement and an additional link for the content landing page.

When the advertisement is played on the client, whether there is content to be resumed locally is first determined. If there is content to be resumed locally, a corresponding resumption module is displayed on a launch-screen page based on different types of content (for example, audio/video/picture-text/novel), and the accompanying launch-screen advertisement is played at the same time. In addition, if there is a link for a specified content landing page, the specified content landing page is preferentially used.

When a click/tap operation on another part other than the resumption module on the launch screen page is detected, an advertisement landing page is entered. When a click/tap operation on the resumption module is detected, the content landing page may be entered. After the content landing page is entered, an advertisement on the content landing page is requested from the advertisement platform based on a request carrying information regarding an accompanying launch screen display and advertisement identifier. The advertisement platform returns the bound advertisement on the content landing page based on a binding relationship. The page 302 in FIG. 3 corresponds to an example where an advertisement in a corresponding form may be displayed in the promotion area on the content landing page, and the advertisement landing page is entered after clicking/tapping.

In addition, based on different content forms and content landing page scenarios, the resumption module may have a plurality of different styles and structures, and the advertisement position on the content landing page may also have a plurality of forms.

In this disclosure, by using the content resumption module, a user may quickly return to content that was not completely displayed last time. This reduces a possibility of leaving an application because an interruption point cannot be found, thereby improving a user retention rate. The user does not need to search for a location at which the content was watched last time among a large quantity of content, and can return to the interruption point with only one click/tap. This greatly reduces operation complexity. For users who frequently uses the application, the playback resumption function greatly simplifies a use procedure of the users, and this user-friendly design is likely to improve user satisfaction and loyalty.

In addition, in cooperation with the content resumption module, the launch-screen advertisement not only provides a valuable service (a resumption function) for the user, but also displays the advertisement at a key user interaction moment. Such a combination is more likely to attract user attention and generate a positive advertising effect, thereby improving an advertising benefit, and increasing a commercial value of the application. An advertiser may prefer to deliver an advertisement in such an application because the application not only displays the advertisement, but also provides an actual value for the user. Such an advertisement usually has a higher interaction rate and a higher conversion rate. In addition, in an application market with increasingly rich functions, such an innovative function may become a key factor for the application to stand out, and helps the application to obtain an advantage in competition.

In a current digital medium consumption environment, the user usually switches between a plurality of devices and applications, to watch or listen to various content. In this scenario, due to other disturbance or emergencies in life, the user may often be forced to be interrupted when watching or listening to content. As a result, when returning to the application, the user usually needs to spend additional time and energy to search for a location at which a previous interruption occurred. Consequently, overall user satisfaction is reduced.

This disclosure provides a system and a method for prompting resumption content. This can implement a function of quickly navigating to an interruption point by providing a content resumption module at a conspicuous location when a user restarts an application. In this way, the user can easily find and resume content that was not completely played last time.

Specifically, when the user starts the software again, the system first reads a playback historical record database stored locally or in a cloud, to quickly determine a last playback location of the user and related data. The system then generates a dynamic “content resumption module” based on the information, and displays the dynamic “content resumption module” to the user on a startup screen in a conspicuous manner. In conclusion, in this disclosure, complex backend processing and intuitive frontend display are effectively combined, to provide efficient and intuitive resumption experience for the user.

It may be learned from the foregoing descriptions that, in the embodiments, when the content application is started, the application startup page may be displayed. The application startup page includes the promotion content picture for the target promotion object and the historical content display area. The historical content display area includes the information related to the target content and the prompt information associated with the target promotion object. The target content is the content that was not completely displayed on the content application in the historical time period, and the prompt information is configured for prompting continuation of watching the target content. The content page is displayed in response to the interaction operation on the historical content display area, so as to continue to display the target content in the content display area on the content page based on the historical display progress of the target content. The content page includes the promotion area, and the promotion area is configured for displaying promotion content for the target promotion object.

In this disclosure, the information related to the target content that was not completely displayed historically on the content application may be directly displayed on the application startup page. Directly jumping to the corresponding content page for continuing to display the target content can be performed through the interaction operation. This can help the user quickly return to the previously uncompleted content, and reduces complexity of user operations. In addition, the user can be prevented from spending a large amount of time and energy to search for the previously uncompleted content. This is conductive to improving user satisfaction on the content application, thereby improving a user retention rate. In addition, in cooperation with display of the information related to the target content that was not completely displayed historically, the promotion content on the application startup page can attract more attention of the user, thereby improving an interaction rate and a conversion rate of the promotion content.

Based on the method described in the foregoing embodiment, the following further provides detailed descriptions by using an example in which the content display apparatus is specifically integrated into a terminal.

An embodiment of this disclosure provides a content display method. As shown in FIG. 9, a specific procedure of the content display method may include the following operations.

901: A terminal displays an application startup page when a content application is started, where the application startup page includes a promotion content picture for a target promotion object and a historical content display area, the historical content display area includes information related to target content and prompt information associated with the target promotion object, the target content is content that was not completely displayed on the content application in a historical time period, and the prompt information is configured for prompting continuation of watching the target content.

902: The terminal displays a content page in response to an interaction operation on the historical content display area, so as to continue to display the target content in a content display area on the content page based on a historical display progress of the target content, where the content page includes a promotion area, and the promotion area is configured for displaying promotion content for the target promotion object.

In this disclosure, the information related to the target content that was not completely displayed historically on the content application may be directly displayed on the application startup page. Directly jumping to the corresponding content page for continuing to display the target content can be performed through the interaction operation. This can help a user quickly return to the previously uncompleted content, and reduces complexity of user operations. In addition, the user can be prevented from spending a large amount of time and energy to search for the previously uncompleted content. This is conductive to improving user satisfaction on the content application, thereby improving a user retention rate. In addition, in cooperation with display of the information related to the target content that was not completely displayed historically, the promotion content on the application startup page can attract more attention of the user, thereby improving an interaction rate and a conversion rate of the promotion content.

To better implement the foregoing methods, an embodiment of this disclosure further provides a content display apparatus. As shown in FIG. 10, the content display apparatus may include a first display unit 1001 and a second display unit 1002. Details are as follows:

### (1) First Display Unit 1001

The first display unit is configured to: display an application startup page when a content application is started, the application startup page including a promotion content picture for a target promotion object and a historical content display area; and display, in the historical content display area, information related to target content that was not completely displayed on the content application in a historical time period, and display prompt information associated with the target promotion object, the prompt information being configured for prompting continuation of watching the target content.

### (2) Second Display Unit 1002

The second display unit is configured to: display a content page in response to an interaction operation on the historical content display area, the content page including a content display area and a promotion area; display the target content in the content display area based on a historical display progress of the target content; and display promotion content for the target promotion object in the promotion area.

In some embodiments of this disclosure, the application startup page further includes a content recommendation area, and the content display apparatus further includes a recommendation unit, configured to: display information related to recommended content in the content recommendation area, the recommended content being determined based on historical usage behavior information generated in the content application; and display a recommended content page in response to an interaction operation on the content recommendation area, and display the recommended content on the recommended content page.

In some embodiments of this disclosure, the application startup page includes a promotion content area, and the content display apparatus may further include a promotion content unit, configured to: display the promotion content picture for the target promotion object in the promotion content area; and display a promotion content page for the target promotion object in response to a trigger operation on the promotion content area.

In some embodiments of this disclosure, the content display area includes a first content display area and a second content display area, the first content display area is configured for displaying the target content, and the content display apparatus further includes: a content description information display unit, configured to display content description information of the target content in the second content display area; and a promotion area display unit, configured to superimpose the promotion area on the second content display area, and highlight the promotion area with a preset effect.

In some embodiments of this disclosure, the promotion area is highlighted at first definition, the second content display area is displayed at second definition, the first definition is higher than the second definition, and the content display apparatus may further include a close unit. Details are as follows:

The close unit is configured to hide the promotion area in response to a close operation on the promotion area, and display the second content display area at the first definition.

In some embodiments of this disclosure, the second display unit may be specifically configured to display, in the content display area on the content page based on the historical display progress of the target content, a content segment associated with a target content segment in the target content, the target content segment being a content segment that is in the target content and that was not completely displayed.

In some embodiments of this disclosure, the historical content display area includes target commodity information integrated with the information related to target content, the target commodity information being commodity information associated with the target promotion object.

In some embodiments of this disclosure, the first display unit may be specifically configured to display the application startup page when the content application is started and there is content that was not completely displayed in the historical time period.

In some embodiments of this disclosure, the content display apparatus may further include a third display unit, configured to display an original application startup page when the content application is started and there is no content that was not completely displayed in the historical time period, the original application startup page including the promotion content picture for the target promotion object and not including the historical content display area.

In some embodiments of this disclosure, the content display apparatus may further include a fourth display unit and a fifth display unit.

The fourth display unit is configured to display a preset application startup page when the content application is started and there is no content that was not completely displayed in the historical time period, the preset application startup page including the promotion content picture for the target promotion object and a preset content display area, the preset content display area including information related to preset content, and the preset content being content bound to the target promotion object.

The fifth display unit is configured to display, in response to an interaction operation on the preset content display area, a content page corresponding to the preset content.

In some embodiments of this disclosure, the application startup page further includes a jump control. The content display apparatus may further include a jump unit, configured to display an application main page of the content application in response to a trigger operation on the jump control.

In some embodiments of this disclosure, the content display apparatus may further include a sixth display unit, configured to display the application main page of the content application when no trigger operation on the application startup page is detected in a preset time period.

In some embodiments of this disclosure, the second display unit may include an extraction subunit, a calculation subunit, and a switching subunit. Details are as follows:

The extraction subunit is configured to extract semantic feature information from collected voice information.

The calculation subunit is configured to calculate a matching degree between the voice information and preset voice interaction information based on the semantic feature information of the voice information and semantic feature information of the preset voice interaction information corresponding to the historical content display area.

The switching subunit is configured to display the content page based on the matching degree.

It may be learned from the foregoing descriptions that, in this embodiment, when the content application is started, the first display unit 1001 may be for displaying the application startup page. The application startup page includes the promotion content picture for the target promotion object and the historical content display area. The historical content display area includes the information related to the target content and the prompt information associated with the target promotion object. The target content is the content that was not completely displayed on the content application in the historical time period, and the prompt information is configured for prompting continuation of watching the target content. The second display unit 1002 is for displaying the content page in response to the interaction operation on the historical content display area, so as to continue to display the target content in the content display area on the content page based on the historical display progress of the target content. The content page includes the promotion area, and the promotion area is configured for displaying the promotion content for the target promotion object.

In this disclosure, the information related to the target content that was not completely displayed historically on the content application may be directly displayed on the application startup page. Directly jumping to the corresponding content page for continuing to display the target content can be performed through the interaction operation. This can help a user quickly return to the previously uncompleted content, and reduces complexity of user operations. In addition, the user can be prevented from spending a large amount of time and energy to search for the previously uncompleted content. This is conductive to improving user satisfaction on the content application, thereby improving a user retention rate. In addition, in cooperation with display of the information related to the target content that was not completely displayed historically, the promotion content on the application startup page can attract more attention of the user, thereby improving an interaction rate and a conversion rate of the promotion content.

An embodiment of this disclosure further provides an electronic device. FIG. 11 shows a schematic structural diagram of an electronic device according to an embodiment of this disclosure. The electronic device may be a terminal, a server, or the like.

In one or more embodiments, the electronic device may include processing circuitry such as a processor 1101 with one or more processing cores, a memory 1102 with one or more computer-readable storage media, a power supply 1103, an input unit 1104, and/or other suitable components. A person skilled in the art may understand that the structure of the electronic device shown in FIG. 11 does not constitute a limitation on the electronic device, and the electronic device may include more components or fewer components than those shown in the figure, or some components may be combined, or a different component arrangement may be used. The processor 1101 is a control center of the electronic device. The processor is connected to various parts of the entire electronic device by using various interfaces and lines, and performs various functions of the electronic device and processes data by running or executing a software program and/or a module stored in the memory 1102 and calling data stored in the memory 1102.

In some embodiments, the processor 1101 may include one or more processing cores. In some embodiments, the processor 1101 may integrate an application processor and a modem processor. The application processor mainly processes an operating system, a user interface, an application program, and the like. The modem processor mainly processes wireless communication. In some embodiments, the foregoing modem processor may not be integrated into the processor 1101.

The memory 1102 may be configured to store a software program and a module. The processor 1101 performs various functional applications and data processing by running the software program and the module stored in the memory 1102. The memory 1102 may mainly include a program storage area and a data storage area. In some embodiments, the memory 1102 may include a non-transitory computer-readable storage medium configured to store a software program or instructions executable by the processor 1101. The program storage area may store an operating system, an application program required by at least one function (for example, a sound playback function and an image playback function), and the like. The data storage area may store data or the like created based on use of the electronic device. In addition, the memory 1102 may include a high-speed random access memory, and may further include a non-volatile memory, for example, at least one magnetic disk storage device, a flash memory device, or another volatile solid-state storage device. Correspondingly, the memory 1102 may further include a memory controller, so that the processor 1101 can access the memory 1102.

The electronic device further includes the power supply 1103 supplying power to various components. In some embodiments, the power supply 1103 may be logically connected to the processor 1101 via a power supply management system, thereby implementing functions such as charging, discharging, and power consumption management via the power management system. The power supply 1103 may further include one or more direct current or alternating current power supplies, a re-charging system, a power failure detection circuit, a power supply converter or inverter, a power supply state indicator, and any other component.

The electronic device may further include the input unit 1104. The input unit 1104 may be configured to receive inputted numeric or character information and generate keyboard, mouse, joystick, optical, or trackball signal input related to user settings and function control.

Although not shown in the figure, the electronic device may further include a display unit, and the like. Details are not described herein. Specifically, in this embodiment, the processor 1101 in the electronic device may load, according to the following instructions, executable files corresponding to processes of one or more application programs into the memory 1102. The processor 1101 runs the application programs stored in the memory 1102 (for example, a non-transitory computer-readable storage medium), to implement various functions, including:

displaying an application startup page when a content application is started, the application startup page including a promotion content picture for a target promotion object and a historical content display area; displaying, in the historical content display area, information related to target content that was not completely displayed on the content application in a historical time period, and displaying prompt information associated with the target promotion object, the prompt information being configured for prompting continuation of watching the target content; displaying a content page in response to an interaction operation on the historical content display area, the content page including a content display area and a promotion area; displaying the target content in the content display area based on a historical display progress of the target content; and displaying promotion content for the target promotion object in the promotion area.

For examples of specific implementations of the foregoing operations, reference can be made to the foregoing embodiments. Details are not described herein again.

It may be learned from the foregoing descriptions that, in this embodiment, when the content application is started, the application startup page may be displayed. The application startup page includes the promotion content picture for the target promotion object and the historical content display area. The historical content display area includes the information related to target content and the prompt information associated with the target promotion object. The target content is the content that was not completely displayed on the content application in the historical time period, and the prompt information is configured for prompting continuation of watching the target content. The content page is displayed in response to the interaction operation on the historical content display area, so as to continue to display the target content in the content display area on the content page based on the historical display progress of the target content. The content page includes the promotion area, and the promotion area is configured for displaying the promotion content for the target promotion object.

In this disclosure, the information related to the target content that was not completely displayed historically on the content application may be directly displayed on the application startup page. Directly jumping to the corresponding content page for continuing to display the target content can be performed through the interaction operation. This can help a user quickly return to the previously uncompleted content, and reduces complexity of user operations. In addition, the user can be prevented from spending a large amount of time and energy to search for the previously uncompleted content. This is conductive to improving user satisfaction on the content application, thereby improving a user retention rate. In addition, in cooperation with display of the information related to the target content that was not completely displayed historically, the promotion content on the application startup page can attract more attention of the user, thereby improving an interaction rate and a conversion rate of the promotion content.

A person of ordinary skill in the art may understand that, all or some operations of various methods in the foregoing embodiments may be implemented by using instructions, or may be implemented by controlling related hardware by using instructions, where the instructions may be stored in a computer-readable storage medium and loaded and executed by a processor.

Therefore, an embodiment of this disclosure provides a computer-readable storage medium, having a plurality of instructions stored therein. The instructions can be loaded by a processor, to perform operations in any content display method provided in the embodiments of this disclosure. For example, the instructions may be for performing the following operations:

displaying an application startup page when a content application is started, where the application startup page includes a promotion content picture for a target promotion object and a historical content display area, the historical content display area includes information related to target content and prompt information associated with the target promotion object, the target content is content that was not completely displayed on the content application in a historical time period, and the prompt information is configured for prompting continuation of watching the target content; and displaying a content page in response to an interaction operation on the historical content display area, so as to continue to display the target content in a content display area on the content page based on a historical display progress of the target content, where the content page includes a promotion area, and the promotion area is configured for displaying promotion content for the target promotion object.

For examples of specific implementations of the foregoing operations, reference can be made to the foregoing embodiments. Details are not described herein again.

The computer-readable storage medium may include: a read only memory (ROM), a random access memory (RAM), a magnetic disk, an optical disc, or the like.

Because the instructions stored in the computer-readable storage medium may be for performing the operations in any content display method provided in the embodiments of this application, the instructions may be for implementing beneficial effects that can be achieved in any content display method provided in the embodiments of this application. For examples, reference can be made to the foregoing embodiments. The details are not described herein again.

According to an aspect of this disclosure, a computer program product or a computer program is provided, the computer program product or the computer program including computer instructions. The computer instructions are stored in a non-transitory computer-readable storage medium. A processor of an electronic device reads the computer instructions from the non-transitory computer-readable storage medium, and the processor executes the computer instructions, so that the electronic device performs the methods provided in various implementations according to the foregoing content display aspects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The technical features in the foregoing embodiments may be combined in various manners. To make the description concise, not all possible combinations of the technical features in the foregoing embodiments are described. However, provided that the combinations of the technical features do not conflict with each other, the combinations of the technical features are considered to be within the scope of this disclosure.

The foregoing embodiments only describe several non-limiting implementations of this disclosure, which are described in detail, and should not be understood as a limitation on the scope of the present disclosure. Other variations and improvements may fall within the scope of this disclosure.

What is claimed is:

1. A content display method, comprising:
displaying an application startup page when a content application is started, the application startup page including a promotion content picture associated with a target promotion object and including a historical content display area;
displaying content information and prompt information in the historical content display area, the content information being related to target content of which display was interrupted within a historical time period, and the prompt information being associated with the target promotion object and indicating resumption of the display of the target content; and
based on a first interaction operation on the historical content display area,
displaying, by processing circuitry, a content page including a content display area and a promotion area;
resuming the display of the target content in the content display area based on a historical display progress of the target content; and
displaying promotion content associated with the target promotion object in the promotion area.

2. The method according to claim 1, wherein
the application startup page includes a content recommendation area, and
the method further includes:
displaying recommendation information related to recommended content in the content recommendation area, the recommended content being determined based on historical usage behavior information generated in the content application; and
based on a second interaction operation on the content recommendation area,
displaying a recommended content page on the content recommendation area; and
displaying the recommended content on the recommended content page.

3. The method according to claim 1, wherein
the application startup page includes a promotion content area, and
the method further includes:
displaying the promotion content picture associated with the target promotion object in the promotion content area; and
displaying a promotion content page associated with the target promotion object based on a trigger operation on the promotion content area.

4. The method according to claim 1, wherein
the content display area includes a first content display area and a second content display area, the first content display area being configured to display the target content, and
the method further includes:
displaying content description information of the target content in the second content display area; and
superimposing the promotion area on the second content display area, the promotion area being highlighted based on a preset effect.

5. The method according to claim 4, wherein
the promotion area is highlighted based on a first display definition,
the second content display area is displayed based on a second display definition, the second display definition corresponding to having a lower resolution, a lower brightness level, a stronger blur effect, a stronger shadow effect, or a combination thereof, than the first display definition, and
the method further comprises, based on a close operation on the promotion area:
hiding the promotion area; and
displaying the second content display area based on the first definition.

6. The method according to claim 1, wherein the resuming the display of the target content comprises:
displaying, in the content display area on the content page based on the historical display progress of the target content, a content segment associated with a target content segment in the target content, the display of the target content being interrupted within the historical time period at the target content segment.

7. The method according to claim 1, further comprising:
displaying, in the historical content display area, target commodity information integrated with the content information related to target content, the target commodity information being associated with the target promotion object.

8. The method according to claim 1, wherein the displaying the application startup page comprises:
displaying the application startup page based on presence of the target content of which the display was interrupted within the historical time period.

9. The method according to claim 8, further comprising:
displaying an original application startup page when the content application is started based on absence of any content of which display was interrupted within the historical time period, the original application startup page including the promotion content picture associated with the target promotion object and not the historical content display area.

10. The method according to claim 8, further comprising:
displaying a preset application startup page when the content application is started based on absence of any content of which display was interrupted within the historical time period, the preset application startup page including the promotion content picture associated with the target promotion object and a preset content display area, the preset content display area including bound content information related to preset content bound to the target promotion object; and
displaying, based on a third interaction operation on the preset content display area, a content page corresponding to the preset content.

11. The method according to claim 1, wherein
the application startup page includes a jump control, and
the method further comprises:
displaying an application main page of the content application based on a trigger operation on the jump control.

12. The method according to claim 11, further comprising:
displaying the application main page of the content application when no trigger operation on the application startup page is detected within a preset time period.

13. The method according to claim 1, wherein the displaying the content page based on the first interaction operation on the historical content display area comprises:
extracting semantic feature information from collected voice information;
calculating a matching degree between the voice information and preset voice interaction information based on the semantic feature information of the voice information and semantic feature information of the preset voice interaction information corresponding to the historical content display area; and
displaying the content page based on the matching degree.

14. A content display apparatus, comprising:
processing circuitry configured to:
display an application startup page when a content application is started, the application startup page including a promotion content picture associated with a target promotion object and including a historical content display area;
display content information and prompt information in the historical content display area, the content information being related to target content of which display was interrupted within a historical time period, and the prompt information being associated with the target promotion object and indicating resumption of the display of the target content; and
based on a first interaction operation on the historical content display area,
display a content page including a content display area and a promotion area;
resume the display of the target content in the content display area based on a historical display progress of the target content; and
display promotion content associated with the target promotion object in the promotion area.

15. The apparatus according to claim 14, wherein
the application startup page includes a content recommendation area, and
the processing circuitry is configured to:
display recommendation information related to recommended content in the content recommendation area, the recommended content being determined based on historical usage behavior information generated in the content application; and
based on a second interaction operation on the content recommendation area,
display a recommended content page on the content recommendation area; and
display the recommended content on the recommended content page.

16. The apparatus according to claim 14, wherein
the application startup page includes a promotion content area, and
the processing circuitry is configured to:
display the promotion content picture associated with the target promotion object in the promotion content area; and
display a promotion content page associated with the target promotion object based on a trigger operation on the promotion content area.

17. The apparatus according to claim 14, wherein
the content display area includes a first content display area and a second content display area, the first content display area being configured to display the target content, and
the processing circuitry is configured to:
display content description information of the target content in the second content display area; and
superimpose the promotion area on the second content display area, the promotion area being highlighted based on a preset effect.

18. The apparatus according to claim 14, wherein, to display the application startup page, the processing circuitry is configured to:
display the application startup page based on presence of the target content of which the display was interrupted within the historical time period.

19. The apparatus according to claim 14, wherein
the application startup page includes a jump control, and
the processing circuitry is configured to display an application main page of the content application based on a trigger operation on the jump control.

20. A non-transitory computer-readable storage medium storing instructions, which when executed by a processor, cause the processor to perform:
displaying an application startup page when a content application is started, the application startup page including a promotion content picture associated with a target promotion object and including a historical content display area;
displaying content information and prompt information in the historical content display area, the content information being related to target content of which display was interrupted within a historical time period, and the prompt information being associated with the target promotion object and indicating resumption of the display of the target content; and
based on a first interaction operation on the historical content display area,
displaying a content page including a content display area and a promotion area;
resuming the display of the target content in the content display area based on a historical display progress of the target content; and
displaying promotion content associated with the target promotion object in the promotion area.
